(19) United States
(12) Patent Application Publication
(10) Pub. No.: US 2010/0156920 A1
(43) Pub. Date: Jun. 24, 2010

(54) APPARATUS AND METHOD FOR SYNTHESIZING TIME-COHERENT TEXTURE

(75) Inventors: Seung Hyup SHIN, Daejeon (KR); Bon Ki Koo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/537,556

(22) Filed: Aug. 7, 2009

(30) Foreign Application Priority Data
Dec. 22, 2008 (KR) 10-2008-0131219

(51) Int. Cl. G09G 5/00

(52) U.S. Cl. 345/582

(57) ABSTRACT

The present invention relates to an apparatus for time-coherent texture synthesis including a texture preprocessor for receiving as input information a 2D texture image and a 3D triangular mesh, and preprocessing the 2D texture image in a form suitable to rapid searching, a vector field generator for defining a vector field on a 3D surface of the 3D triangular mesh, a color search unit for finding a color of each edge of a triangle having the defined vector field in consideration of a previous frame, and a texture synthesizer for determining texture coordinates of the triangle using the found colors. The texture preprocessor further receives information regarding a size of the texture to be synthesized and an initial vector field orientation.

### CROSS-REFERENCE(S) TO RELATED APPLICATIONS

The present invention claims priority of Korean Patent Application No. 10-2008-0131219, filed on Dec. 22, 2008, which is incorporated herein by reference.

### FIELD OF THE INVENTION

The present invention relates to texture synthesis and, more particularly, to an apparatus and method for time-coherent texture synthesis that are suitable for synthesizing 2-dimensional texture images on 3-dimensional surfaces represented by a triangular mesh.

### BACKGROUND OF THE INVENTION

Texture synthesis is one of long standing themes in the computer vision field. Many existing techniques are point-based approaches, in which numerous sampling points are defined on a 3D triangular mesh and colors are assigned to the points in sequence until a pattern visually similar to the original 2D texture image is synthesized. Instead of sampling points, individual triangles are adopted as units of synthesis in a paper published by Magda and Kriegman in 2003.

In the work of Magda and Kriegman, a smooth vector field is defined over the triangular mesh, and a first triangle is randomly selected. Texture is synthesized on the first triangle by mapping the first triangle to coordinates of a 2D texture image. Then, triangles neighboring the pre-synthesized triangle are selected in sequence and mapped. During this process, to form a continuous and smooth appearance, colors of the pre-textured triangles are taken into consideration.

As described above, a triangle-based approach is faster than a point-based approach because the number of triangles is less than that of sampling points, and can produce a synthesis result having a spatially continuous appearance by taking the color of pre-synthesized neighbors into account. This approach is well-suited for meshes of fixed-shaped objects, but however may be not suitable for objects with continuously varying surface appearances such as water.

That is to say, the existing approaches can produce a spatially continuous synthesis result within a single time frame, but it may be incapable of avoiding irregular popping effects in texture color because of lack of a means for assuring synthesis continuity between consecutive frames.

### SUMMARY OF THE INVENTION

It is, therefore, an object of the present invention to provide an apparatus and a method for time-coherent texture synthesis that can synthesize 2D texture images on 3D surfaces represented by a triangular mesh.

It is, therefore, another object of the present invention is to provide an apparatus and method for time-coherent texture synthesis that can synthesize a smoothly changing texture on even a surface suddenly varying in shape or phase with time like water.

It is, therefore, still another object of the present invention is to provide an apparatus and method for time-coherent texture synthesis that can maximally preserve texture continuity between frames by forcing the current frame texture to reflect the previous frame texture in the course of synthesizing a 2D texture image on a 3D surface represented by a triangular mesh.

In accordance with one aspect of the invention, there is provided an apparatus for time-coherent texture synthesis including a texture preprocessor for receiving as input information a 2D texture image and a 3D triangular mesh, and preprocessing the 2D texture image in a form suitable to rapid searching; a vector field generator for defining a vector field on a 3D surface of the 3D triangular mesh; a color search unit for finding a color of each edge of a triangle having the defined vector field in consideration of a previous frame; and a texture synthesizer for determining texture coordinates of the triangle using the found colors.

It is desirable that the texture preprocessor further receives information regarding a size of the texture to be synthesized and an initial vector field orientation.

It is also desirable that the texture preprocessor performs convolutions between a template of a given size centered at each texel and Gabor filters, and stores the convolution results at the location of each texel to produce Gabor filter response images.

It is preferable that for a first frame, the vector field generator defines a vector in the tangential direction of each triangle, and produces a final vector field by repeatedly substituting the vector direction of the triangle with an average of vector directions of neighbor triangles of the triangle.

It is also preferable that the vector field generator obtains vectors of triangles in a second or later frame through interpolation using a vector field of the previous frame, and produces a final vector field by repeatedly substituting a vector direction of each of the triangles with an average of vector directions of neighbor triangles of the triangle.

It is preferred that in a state where a center of each of the triangles is pre-stored as a kd-tree structure, the interpolation is performed by searching the previous frame for vectors present within a preset range from the center of each of the triangles and taking a weighted-average of the searched vectors in accordance with their distances from the center.

It is also preferred that for a first frame, the texture synthesizer repeats, until all triangles in the first frame perform texture synthesize, a texture-synthesized process of selecting a triangle, assigning any texture coordinates to the selected triangle, storing pre-assigned texture colors in neighboring triangles of the selected triangle as a 2D image, and finding the most similar coordinate in the input 2D texture image utilizing the stored 2D image to perform texture synthesize.

It is still desirable that for a second or later frame, the texture synthesizer repeats a texture-synthesized process of selecting a triangle, mapping the selected triangle to 2D texture coordinates, transferring a mapped texel to a 3D object space and finding particles within a preset range to identify a color of each mapped texel in the previous frame, identifying a movement vector of each of the found particles, obtaining an advection vector of the selected triangle by taking a weighted-average of the movement vectors, computing a position of the selected triangle in the previous frame utilizing the advection vector, finding the closest triangle from the position in the previous frame, identifying texture colors assigned to three edges of the found triangle, and finding the most similar texture coordinates in the input 2D texture image.

It is still preferable that the texture synthesizer concurrently synthesizes triangles in a second or later frame utilizing at least two threads.

It is still preferred that the apparatus includes a texture coordinate unit for receiving results of texture coordinate assignment from the texture synthesizer, and for verifying texture coordinate assignment for all of the triangles; and a rendering unit for performing a rendering procedure based on the results of texture coordinate assignment from the texture coordinate unit and the 3D triangular mesh to output a synthesized image.

In accordance with another aspect of the invention, there is provided a method of time-coherent texture synthesis including receiving as input information a 2D texture image and a 3D triangular mesh; preprocessing the 2D texture image in a form suitable to rapid searching; defining a vector field on a 3D surface of the 3D triangular mesh; finding a color of each edge of a triangle having the defined vector in consideration of a previous frame; and performing texture synthesis by determining texture coordinates of the triangle using the found colors.

It is desirable that in the receiving as input, information regarding a size of the texture to be synthesized and an initial vector field orientation is further received.

It is also desirable that the preprocessing the 2D texture image has performing convolutions between a template of a given size centered at each texel with Gabor filters; and storing the convolution results at the location of each texel to produce Gabor filter response images.

It is still desirable that the defining a vector field has defining, for a first frame, a vector in the tangential direction of each triangle; and producing a final vector field by repeatedly substituting the vector direction of the triangle with an average of vector directions of neighbor triangles of the triangle.

It is preferable that the defining a vector field has obtaining vectors of triangles in a second or later frame through interpolation using a vector field of the previous frame; and producing a final vector field by repeatedly substituting a vector direction of each of the triangles with an average of vector directions of neighbor triangles of the triangle.

It is also preferable that in a state where a center of each of the triangles is pre-stored as a kd-tree structure, the interpolation is performed by searching the previous frame for vectors present within a preset range from the center of each of the triangles and taking a weighted-average of the searched vectors in accordance with their distances from the center.

It is still preferable that the performing texture synthesis includes repeating, until all triangles in the first frame perform texture synthesize, a texture-synthesized process of selecting a triangle, assigning any texture coordinates to the selected triangle; storing pre-assigned texture colors in neighboring triangles of the selected triangle as a 2D image, and finding the most similar coordinate in the input 2D texture image utilizing the stored 2D image to perform texture synthesize.

It is preferred that the performing texture synthesis includes repeating, for a second or later frame, a texture-synthesized process of selecting a triangle, mapping the selected triangle to 2D texture coordinates, transferring a mapped texel to a 3D object space and finding particles within a preset range to identify a color of each mapped texel in the previous frame; identifying a movement vector of each of the found particles, obtaining an advection vector of the selected triangle by taking a weighted-average of the movement vectors; computing a position of the selected triangle in the previous frame utilizing the advection vector; finding the closest triangle from the position in the previous frame, identifying texture colors assigned to three edges of the found triangle; and finding the most similar texture coordinates in the input 2D texture image.

It is also preferred that in the performing texture synthesis, triangles in a second or later frame are concurrently synthesized utilizing at least two threads.

It is still preferred that the method further includes receiving results of texture coordinate assignment, and verifying texture coordinate assignment for all of the triangles; and performing a rendering procedure based on the results of texture coordinate assignment and the 3D mesh to output a textured image.

In a feature of the present invention, the apparatus and method enable synthesis of a smoothly changing texture -on a 3D surface abruptly varying in shape or phase with time like water. Through the use of a triangle as a synthesis unit, texture synthesis can be performed more efficiently in comparison to existing point-based approaches. By adopting multi-threading, synthesis speed can also be significantly increased.

### BRIEF DESCRIPTION OF THE DRAWINGS

The above and other objects and features of the present invention will become apparent from the following description of embodiments given in conjunction with the accompanying drawings, in which:

FIG. 1 describes a block diagram of an apparatus for time-coherent texture synthesis in accordance with an embodiment of the present invention;

FIG. 2 sets forth a flow chart showing a method of time-coherent texture synthesis in accordance with another embodiment of the present invention; and

FIG. 3 illustrates texture synthesis on a triangle.

### DETAILED DESCRIPTION OF THE PREFERRED EMBODIMENTS

Hereinafter, embodiments of the present invention will be described in detail with reference to the accompanying drawings so that they can be readily implemented by those skilled in the art.

The present invention relates to texture synthesis, in which a 2D texture image is synthesized on 3D surfaces represented by a triangular mesh. In particular, a texture synthesis technique is provided that can synthesize a smoothly changing texture on even a surface suddenly varying in shape or phase with time like water.

Unlike the existing texture synthesis approaches, which do not consider surface appearance changes and produce popping effects when applied to changing surfaces, the proposed texture synthesis technique maximally preserves texture continuity between frames by forcing the current frame texture to reflect the previous frame texture.

Hence, the present invention can be effectively applied to an animation involving frequent changes in shape or phase, in which a 3D surface deforms, a hole forms, or an existing hole disappears.

In the description, the word ‘fluid’ indicates an object without a constant shape such as water, fire, or smoke.

The words ‘triangular mesh’ indicates a data structure representing the surface of an object as a set of connected triangles. The triangles are described by vertices, edges, and faces. A ‘vertex’ is a position in a space. An ‘edge’ is a connection between two vertices. A ‘face’ is a closed set of three or more edges.

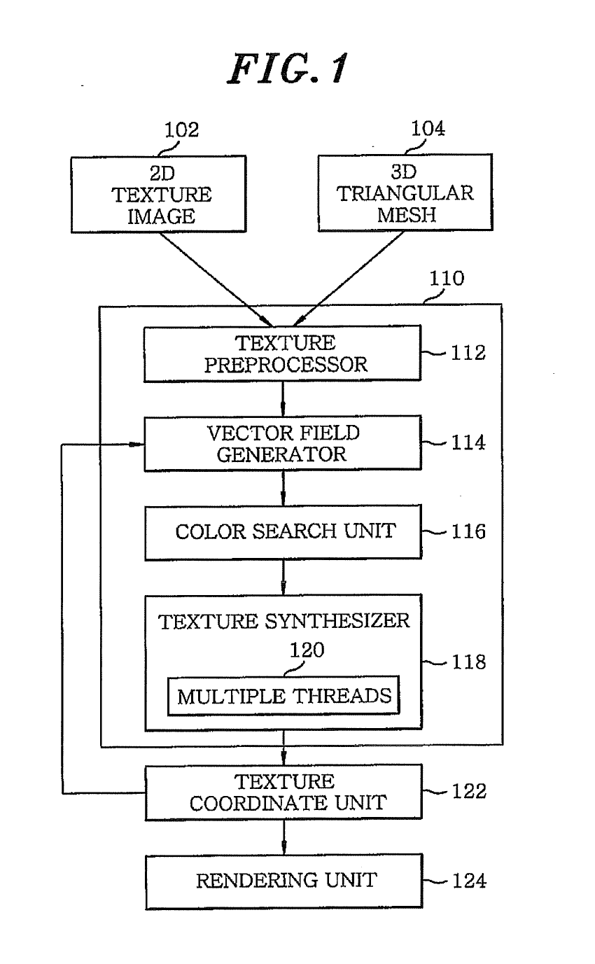

FIG. 1 describes a block diagram of an apparatus 110 for time-coherent texture synthesis in accordance with an embodiment of the present invention.

Referring to FIG. 1, the time-coherent texture synthesis apparatus 110 receives as primary input a 2D texture image 102 and a 3D triangular mesh 104, and can be further given the size of a texture to be synthesized and the initial vector field orientation, etc. as user selectable parameters. Based on these input data, the texture synthesis apparatus 110 maps each triangle from the 3D object space to the 2D texture image space to determine the texture coordinates of three vertices forming the triangle. When all the triangles are mapped, the set of determined texture coordinates become system output. This set of texture coordinates and the original 3D mesh can be given to rendering software to generate a final image.

The texture synthesis apparatus 110 includes a texture preprocessor 112, a vector field generator 114, a color search unit 116, and a texture synthesizer 118, etc., and may further include a texture coordinate unit 122 and a rendering unit 124, etc. depending on the configuration.

As texture synthesis involves a procedure for finding texture coordinates most similar to the texture color assigned to each edge of the current triangle, the texture preprocessor 112 preprocesses the texture image in a form suitable to coordinate searching for efficient texture synthesis. Thereto, convolutions are preformed between each texel, a N×N template centered at each texel and Gabor filters, and the result is stored at each texel. Total 32 Gabor filters at 4 scales and 8 orientations can produce best results. Resultant images are known as Gabor filter response images.

The vector field generator 114 is used to set a coordinate system mapping individual triangles from the 3D object space to the 2D texture space. To produce a spatially and temporally continuous texture, neighboring vectors should have similar orientations.

The vector field of the current frame being synthesized is computed differently depending upon whether the current frame is a first frame or not. If the current frame is the first frame, there is no need to consider temporal continuity from the previous frame, and it is sufficient to compute a spatially smooth vector field. Thereto, for each triangle, a vector is defined in the tangential direction of the triangle. The vector field defined in this way is smoothed in a stepwise manner for spatial continuity.

In an embodiment, the vector field generator 114 produces the final vector field by repeatedly substituting the vector direction of a triangle with an average of vector directions of the neighbor triangles of the triangle. The resultant vector field may have a singularity, at which the magnitude and direction of a vector are indeterminate, depending upon a mesh shape and a phase. However, this does not affect the result at a meaningful level when no directionality is present in the texture pattern, and does not significantly lower quality even when directionality is present in the texture pattern.

In the case when the current frame is a second or later frame, the vector field of the current frame should be formed to be similar to that of the previous frame to preserve temporal continuity. Unlike the first frame where the initial vector of each triangle is set randomly, the vectors of the second or later frame are interpolated from the vector field of the previous frame. Thereto, it is necessary to search the previous frame for vectors present within a preset range from the center of a triangle, and hence triangle centers are stored in a kd-tree for efficient search. An interpolated vector is obtained by taking a weighted-average of the found existing vectors in accordance with their distances from the center. The interpolated vector field is smoothed in a stepwise manner as in the case of the first frame.

The color search unit 116 and the texture synthesizer 118 synthesize a texture for each triangle by assigning 2D texture coordinates to individual vertices forming the triangle. The color search unit 116 samples the texture color of each edge with respect to each triangle, and the texture synthesizer 118 performs texture synthesis using the sampled texture colors.

In the case of the first frame, a first triangle is selected, and texture coordinates are assigned to the selected triangle. Thereafter, neighbor triangles of an pre-synthesized triangle are synthesized in sequence. Further, a texture color is already assigned to at least one edge of the current triangle. The assigned texture colors are stored as a 2D image. Texture synthesis ends with finding the most similar coordinates in the input 2D texture image utilizing the assigned 2D image. The similar coordinates (x, y) are defined by Equation 1.

$$arg {min}_{( x , y )} {\sum }_{i , j} Diff ( I ( i + x , j + y ) , T ( i , j ) ) \qquad [ Equation 1 ]$$

, where I(a, b) indicates RGB values at the coordinates (a, b) in the assigned texture image, T(a, b) indicates RGB values at the coordinates (a, b) in the input texture image, and Diff indicates the distance therebetween given by Equation 2.

$$Diff ( ( {r}_{0} , {g}_{0} , {b}_{0} ) , ( {r}_{1} , {g}_{1} , {b}_{1} ) ) = \sqrt{\begin{matrix}\begin{matrix}{( {r}_{0} - {r}_{1} )}^{2} + \\ {( {g}_{0} - {g}_{1} )}^{2} +\end{matrix} \\ {( {b}_{0} - {b}_{1} )}^{2}\end{matrix}} \qquad [ Equation 2 ]$$

, where r, g and b refer to the red value, green value and blue value of a pixel, respectively. However, as this approach requires too many computations, the Gabor filter response images pre-computed at the preprocessing step are used to speed up the search.

In the case of the second or later frame, for the current triangle, it is necessary to refer to the colors of triangle edges in the previous frame. How to achieve this is dependent on the fluid simulation scheme. The present embodiment adopts a simulation scheme based on smoothed particle hydrodynamics, in which the movement direction and velocity of a fluid are stored in many particles.

The current triangle is mapped to 2D texture coordinates, and the color of each mapped texel is found in the previous frame. Thereto, the mapped texel is transferred to the 3D object space, and particles within a preset range are found. An advection vector of the current triangle is obtained by taking a weighted-average of movement vectors of the found particles. Hence, the position of the current triangle in the previous frame can be computed using Equation 3.

pᵢ₋₁=pᵢ−v×dt [Equation 3]

, where pᵢ is the position in the current frame, pᵢ₋₁ is the position in the previous frame, v indicates the advection vector, and dt indicates the simulation time interval. By finding the closest triangle from the position in the previous frame, texture colors assigned thereto can be known. With a similar manner, texture colors assigned to the three edges are obtained, and then the most similar texture coordinates are found and assigned to the three vertices as in the case of the first frame.

This texture synthesis approach uses triangles as units of synthesis and is more efficient than an existing approach based on points. Furthermore, for the second and later frames, as texturing of a triangle in the current frame does not affect other triangles, triangles can be synthesized in parallel. On the basis of this fact, the texture synthesizer 118 utilizes multiple threads 120 for concurrent texture synthesis. With mesh data structures replicated corresponding to the number of threads, synthesis speed can be greatly increased (for example, two times faster with four threads).

The texture coordinate unit 122 receives results of texture coordinate assignment for the triangles from the texture synthesizer 118, and verifies the texture coordinates assigned to the triangles of the 3D triangular mesh. If a triangle with no assigned texture coordinates or wrong texture coordinates is detected, the texture coordinate unit 122 sends the detected triangle to the vector field generator 114 for new texture synthesis.

The rendering unit 124 receives the final results of texture coordinate assignment from the texture coordinate unit 122, and can produce the final image through rendering based on the 3D mesh.

Thanks to the final image produced through texture synthesis described above, it is possible to obtain a smoothly changing texture on even an animated fluid surface abruptly varying in shape or phase with time like water.

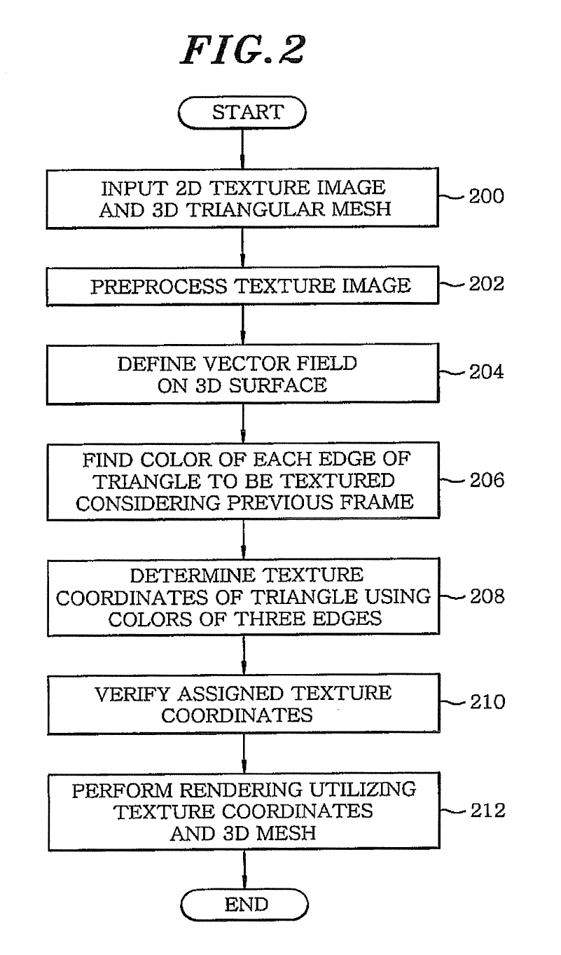

FIG. 2 depicts a flow chart showing a method of time-coherent texture synthesis in accordance with another embodiment of the present invention.

Referring to FIG. 2, at step 200, the texture synthesis apparatus 110 receives as input a 2D texture image and a 3D triangular mesh. At step 202, the texture preprocessor 112 preprocesses the texture image in a form suitable to rapid coordinate searching. At step 204, the vector field generator 114 receives the preprocessed texture image and defines a smooth vector field on a 3D surface. At step 206, the color search unit 116 receives the vector field data and finds the colors of edges of a triangle being synthesized in consideration of the previous frame. At step 208, the texture synthesizer 118 assigns texture coordinates of the triangle using the found colors of the three edges.

At step 210, the texture coordinate unit 122 verifies the determined texture coordinates. At step 212, the rendering unit 124 performs rendering on the basis of the assigned texture coordinates and the 3D triangular mesh.

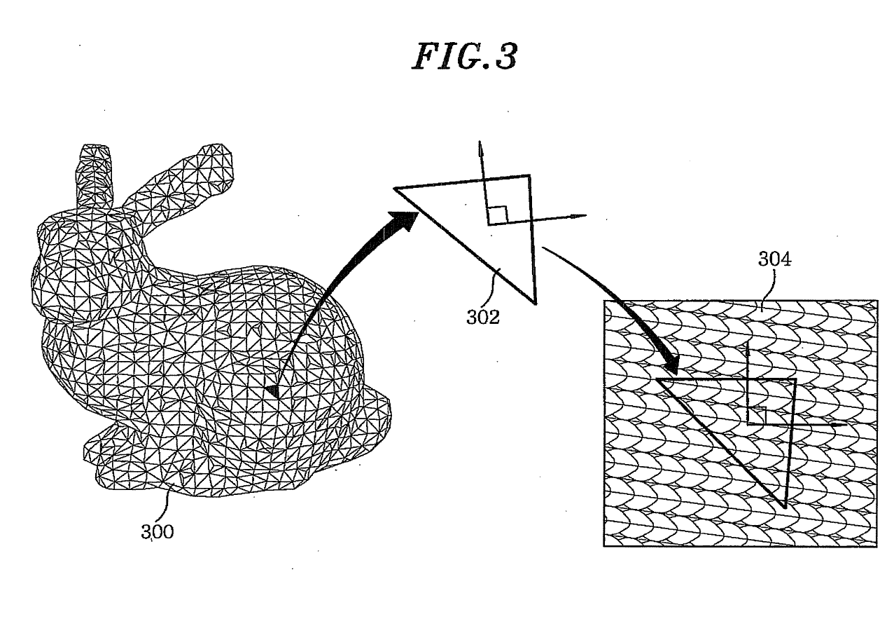

FIG. 3 illustrates texture synthesis on a single triangle.

As shown in FIG. 3, the texture synthesis apparatus receives as input a 2D texture image and a 3D triangular mesh 300, and maps a triangle 302 from the 3D object space to the 2D texture image space 304 to determine the texture coordinates of three vertices forming the triangle 302. When all the triangles are processed, the set of determined texture coordinates become system output. This set of texture coordinates and the original 3D mesh 300 can be used to generate a final image through rendering.

As described above, the present invention provides a texture synthesis method, in which a 2D texture image is synthesized on 3D surfaces represented by a triangular mesh. In particular, the synthesis method enables synthesis of a smoothly changing texture on even a surface suddenly varying in shape or phase with time like water.

While the invention has been shown and described with respect to the embodiments, it will be understood by those skilled in the art that various changes and modifications may be made without departing from the scope of the invention as defined in the following claims.

What is claimed is:

1. An apparatus for time-coherent texture synthesis, comprising:
a texture preprocessor for receiving as input information a 2D texture image and a 3D triangular mesh, and preprocessing the 2D texture image in a form suitable to rapid searching;
a vector field generator for defining a vector field on a 3D surface of the 3D triangular mesh;
a color search unit for finding a color of each edge of a triangle having the defined vector field in consideration of a previous frame; and
a texture synthesizer for determining texture coordinates of the triangle using the found colors.

2. The apparatus of claim 1, wherein the texture preprocessor further receives information regarding a size of the texture to be synthesized and an initial vector field orientation.

3. The apparatus of claim 1, wherein the texture preprocessor performs convolutions between a template of a given size centered at each texel and Gabor filters, and stores the convolution results at the location of each texel to produce Gabor filter response images.

4. The apparatus of claim 1, wherein, for a first frame, the vector field generator defines a vector in the tangential direction of each triangle, and produces a final vector field by repeatedly substituting the vector direction of the triangle with an average of vector directions of neighbor triangles of the triangle.

5. The apparatus of claim 1, wherein the vector field generator obtains vectors of triangles in a second or later frame through interpolation using a vector field of the previous frame, and produces a final vector field by repeatedly substituting a vector direction of each of the triangles with an average of vector directions of neighbor triangles of the triangle.

6. The apparatus of claim 5, wherein, in a state where a center of each of the triangles is pre-stored as a kd-tree structure, the interpolation is performed by searching the previous frame for vectors present within a preset range from the center of each of the triangles and taking a weighted-average of the searched vectors in accordance with their distances from the center.

7. The apparatus of claim 1, wherein, for a first frame, the texture synthesizer repeats, until all triangles in the first frame perform texture synthesize, a texture-synthesized process of selecting a triangle, assigning any texture coordinates to the selected triangle, storing pre-assigned texture colors in neighboring triangles of the selected triangle as a 2D image, and finding the most similar coordinate in the input 2D texture image utilizing the stored 2D image to perform texture synthesize.

8. The apparatus of claim 1, wherein, for a second or later frame, the texture synthesizer repeats a texture-synthesized process of selecting a triangle, mapping the selected triangle to 2D texture coordinates, transferring a mapped texel to a 3D object space and finding particles within a preset range to identify a color of each mapped texel in the previous frame, identifying a movement vector of each of the found particles, obtaining an advection vector of the selected triangle by taking a weighted-average of the movement vectors, computing a position of the selected triangle in the previous frame utilizing the advection vector, finding the closest triangle from the position in the previous frame, identifying texture colors assigned to three edges of the found triangle, and finding the most similar texture coordinates in the input 2D texture image.

9. The apparatus of claim 1, wherein the texture synthesizer concurrently synthesizes triangles in a second or later frame utilizing at least two threads.

10. The apparatus of claim 1, further comprising:
a texture coordinate unit for receiving results of texture coordinate assignment from the texture synthesizer, and for verifying texture coordinate assignment for all of the triangles; and
a rendering unit for performing a rendering procedure based on the results of texture coordinate assignment from the texture coordinate unit and the 3D triangular mesh to output a synthesized image.

11. A method of time-coherent texture synthesis, comprising:
receiving as input information a 2D texture image and a 3D triangular mesh;
preprocessing the 2D texture image in a form suitable to rapid searching;
defining a vector field on a 3D surface of the 3D triangular mesh;
finding a color of each edge of a triangle having the defined vector in consideration of a previous frame; and
performing texture synthesis by determining texture coordinates of the triangle using the found colors.

12. The method of claim 11, wherein in the receiving as input, information regarding a size of the texture to be synthesized and an initial vector field orientation is further received.

13. The method of claim 11, wherein the preprocessing the 2D texture image includes:
performing convolutions between a template of a given size centered at each texel with Gabor filters; and
storing the convolution results at the location of each texel to produce Gabor filter response images.

14. The method of claim 11, wherein the defining a vector field includes:
defining, for a first frame, a vector in the tangential direction of each triangle; and
producing a final vector field by repeatedly substituting the vector direction of the triangle with an average of vector directions of neighbor triangles of the triangle.

15. The method of claim 11, wherein the defining a vector field includes:
obtaining vectors of triangles in a second or later frame through interpolation using a vector field of the previous frame; and
producing a final vector field by repeatedly substituting a vector direction of each of the triangles with an average of vector directions of neighbor triangles of the triangle.

16. The method of claim 15, wherein in a state where a center of each of the triangles is pre-stored as a kd-tree structure, the interpolation is performed by searching the previous frame for vectors present within a preset range from the center of each of the triangles and taking a weighted-average of the searched vectors in accordance with their distances from the center.

17. The method of claim 11, wherein the performing texture synthesis includes repeating, until all triangles in the first frame perform texture synthesize, a texture-synthesized process of
selecting a triangle, assigning any texture coordinates to the selected triangle;
storing pre-assigned texture colors in neighboring triangles of the selected triangle as a 2D image, and
finding the most similar coordinate in the input 2D texture image utilizing the stored 2D image to perform texture synthesize.

18. The method of claim 11, wherein the performing texture synthesis includes repeating, for a second or later frame, a texture-synthesized process of
selecting a triangle, mapping the selected triangle to 2D texture coordinates, transferring a mapped texel to a 3D object space and finding particles within a preset range to identify a color of each mapped texel in the previous frame;
identifying a movement vector of each of the found particles, obtaining an advection vector of the selected triangle by taking a weighted-average of the movement vectors;
computing a position of the selected triangle in the previous frame utilizing the advection vector;
finding the closest triangle from the position in the previous frame, identifying texture colors assigned to three edges of the found triangle; and
finding the most similar texture coordinates in the input 2D texture image.

19. The method of claim 11, wherein in the performing texture synthesis, triangles in a second or later frame are concurrently synthesized utilizing at least two threads.

20. The method of claim 11, further comprising:
receiving results of texture coordinate assignment, and verifying texture coordinate assignment for all of the triangles; and
performing a rendering procedure based on the results of texture coordinate assignment and the 3D mesh to output a textured image.
